(19) United States
(12) Patent Application Publication
(10) Pub. No.: US 2026/0079979 A1
(43) Pub. Date: Mar. 19, 2026

(54) TRAINING METHOD, REFINEMENT METHOD OF TRAINING SAMPLE, AND ELECTRIC DEVICE

(71) Applicant: Industrial Technology Research Institute, Hsinchu (TW)

(72) Inventors: Shu-Hao Ye, Hsinchu County (TW); Shang-De Chen, Kaohsiung City (TW); Chi-Tien Sun, Hsinchu City (TW); Yen-Shyun Huang, Taichung City (TW); Guan-Yao Wang, Yunlin County (TW)

(21) Appl. No.: 18/937,051

(22) Filed: Nov. 5, 2024

(30) Foreign Application Priority Data
Sep. 19, 2024 (TW) 113135477

(51) Int. Cl. G06F 16/33; G06F 16/332; G06F 16/35

(52) U.S. Cl. CPC G06F 16/3344; G06F 16/3329; G06F 16/3347; G06F 16/353

(57) ABSTRACT

The present disclosure provides a training method for a machine learning model and a refinement method for training samples. The training method includes: obtaining feature vectors of the training samples, clustering the feature vectors to obtain representative training samples, and then training the machine learning model based on the representative training samples. The refinement method includes: querying an external database based on an original sample to obtain supplementary data, using a machine learning model to evaluate the original sample to generate review data, and then using another machine learning model to refine the original sample based on the supplementary data and the review data.

### CROSS-REFERENCE TO RELATED APPLICATION

The present application is based on, and claims priority from, Taiwan Application Serial Number 113135477, filed Sep. 19, 2024, the disclosure of which is hereby incorporated by reference.

### BACKGROUND

### Technical Field

The present disclosure relates to a training method and a refinement method that can accelerate the training process of machine learning models and improve performance.

### Description of Related Art

In recent years, with the rapid development of artificial intelligence technology, Large Language Models (LLMs) have become a core technology in many fields. With their powerful language understanding and generation capabilities, they have brought significant benefits and technological revolutions to various industries. These models are widely applied in scenarios such as production line optimization, administrative efficiency improvement, educational training, customer service, game design, and in-vehicle voice control. Through large language models, enterprises can achieve more automated and intelligent processes and services, greatly improving productivity and reducing labor costs.

However, the process of training these large language models is extremely complex and costly. A typical large language model may contain billions or even hundreds of billions of parameters, requiring enormous computational resources. Training these models usually requires a large amount of high-performance hardware resources and may take weeks to months, which not only increases hardware costs but also raises the resource investment for enterprises. This is particularly significant when fine-tuning the models, where resource consumption is especially notable.

In addition to hardware costs, the quality of training samples is also one of the key factors affecting model performance. The diversity and accuracy of training data directly impact the final effectiveness of language models. To ensure the quality of training data, extensive manual cleaning and filtering are usually required, which also increases development costs and time pressure. As the scale of models grows, how to complete high-quality language model training at lower costs and in less time has become an urgent problem to be solved in the industry.

### SUMMARY

An embodiment of the present disclosure proposes a training method for a machine learning model, and executed by an electronic device. This training method includes: obtaining multiple training samples; inputting each training sample into a first machine learning model to obtain a corresponding feature vector; clustering these feature vectors to obtain multiple groups, with each group containing a portion of the feature vectors; extracting a representative feature vector from each group, where this representative feature vector corresponds to a representative training sample, and the quantity of representative training samples is less than the quantity of training samples; and training a second machine learning model according to the representative training samples.

Another embodiment of the present disclosure proposes a refinement method for training samples executed by an electronic device. This refinement method includes: (a) obtaining an original sample; (b) querying an external database according to the original sample to obtain supplementary data; (c) inputting the original sample and a first prompt into a third machine learning model to obtain review data; and (d) inputting the original sample, the supplementary data, the review data, and a second prompt into a fourth machine learning model to obtain a refined sample corresponding to the original sample, where the third machine learning model is different from the fourth machine learning model.

### BRIEF DESCRIPTION OF THE DRAWINGS

FIG. 1 is a schematic diagram illustrating an electronic device according to an embodiment.

FIG. 2 is a flowchart illustrating a training method for a machine learning model according to the first embodiment.

FIG. 3 is a schematic diagram illustrating the construction of a graph based on groups according to the first embodiment.

FIG. 4 is a flowchart illustrating a refinement method for training samples according to the second embodiment.

FIG. 5 is a flowchart illustrating a training method according to the third embodiment.

### DESCRIPTION OF THE EMBODIMENTS

Reference will now be made in detail to the exemplary embodiments of the disclosure, examples of which are illustrated in the accompanying drawings. Whenever possible, the same reference numbers are used in the drawings and the description to refer to the same or like components.

Regarding the use of “first,” “second,” etc. in this document, they do not specifically indicate order or sequence, but are merely used to distinguish elements or operations described with the same technical terms.

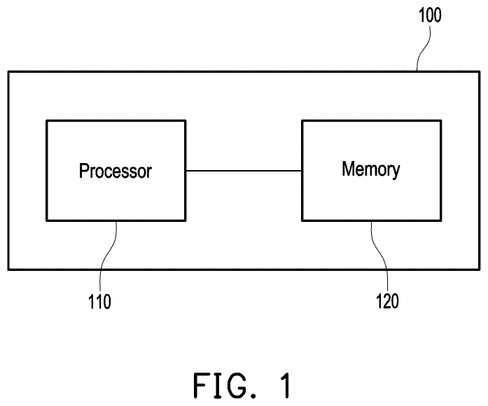

FIG. 1 is a schematic diagram illustrating an electronic device according to an embodiment. Referring to FIG. 1, an electronic device 100 may be a smartphone, tablet computer, personal computer, laptop computer, server, distributed computer, cloud server, industrial computer, or various electronic devices with computing capabilities, but the present invention is not limited to these. The electronic device 100 includes a processor 110 and a memory 120, with the processor 110 communicatively connected to the memory 120. This communication connection may be achieved through any wired or wireless communication means, or through the Internet. The processor 110 may be a central processing unit, graphics processing unit, tensor processing unit, Application Specific Integrated Circuits (ASIC), Programmable Logic Device (PLD), etc. The memory 120 may be random access memory, read-only memory, flash memory, floppy disk, hard disk, optical disc, USB flash drive, magnetic tape, or a database accessible through the Internet, which stores multiple instructions. The processor 110 will execute these instructions to perform the methods described below.

A training method for a machine learning model and a refinement method for training samples are proposed here. These two methods may be executed in combination or separately. Several embodiments will be presented below to illustrate these methods.

### First Embodiment

First, we will explain the training method for the machine learning model. In known techniques, it is generally believed that the more training samples, the better. However, in some cases, the redundancy among these training samples may be high, which may not improve the training results. The method proposed here aims to reduce the quantity of training samples.

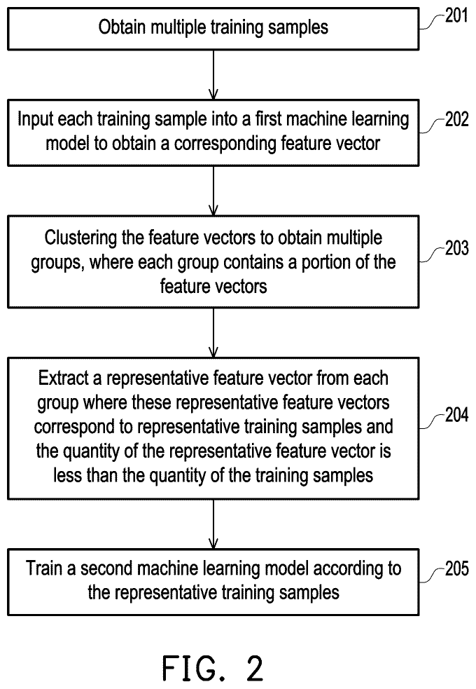

FIG. 2 is a flowchart illustrating the training method for a machine learning model according to the first embodiment. Referring to FIG. 2, in step 201, multiple training samples are obtained. In some embodiments, each training sample includes paired input data and output data for supervised learning. These input data may be images, text, audio signals, data measured by various sensors, etc., but the present invention is not limited to these. Moreover, the aforementioned output data may be a certain type of label, text, image, audio, etc., but the present invention is not limited to these. In some embodiments, training samples may only include input data for unsupervised learning. In other words, the training method proposed here is applicable to any type of data.

In step 202, each training sample is input into a first machine learning model to obtain a corresponding feature vector. In some fields, feature vectors may also be referred to as embeddings. Any known model may be adopted here as the first machine learning model. For example, if the training samples are related to images, the first machine learning model may include a convolutional neural network, and the architecture of this network may adopt LeNet, AlexNet, VGG, GoogLeNet, ResNet, DenseNet, or YOLO (You Only Look Once), etc. If the training samples are related to text, the first machine learning model may be BERT (Bidirectional Encoder Representations from Transformers), GPT (Generative Pre-trained Transformers) series, USE (Universal Sentence Encoder), etc., but the present invention is not limited to these. If the training samples are related to audio signals, the first machine learning model may be Mel-frequency cepstrum model, VGGish, OpenL3, etc., but the present invention is not limited to these. In some embodiments where training samples include paired input data and output data, the feature vectors may be generated based only on the input data, or the input data and output data may be concatenated for generating feature vectors.

In step 203, the feature vectors are clustered to obtain multiple groups, where each group contains a portion of the feature vectors. Any clustering algorithm may be adopted here, including K-Means, Hierarchical Clustering, DBSCAN (Density-Based Spatial Clustering of Applications with Noise), etc.

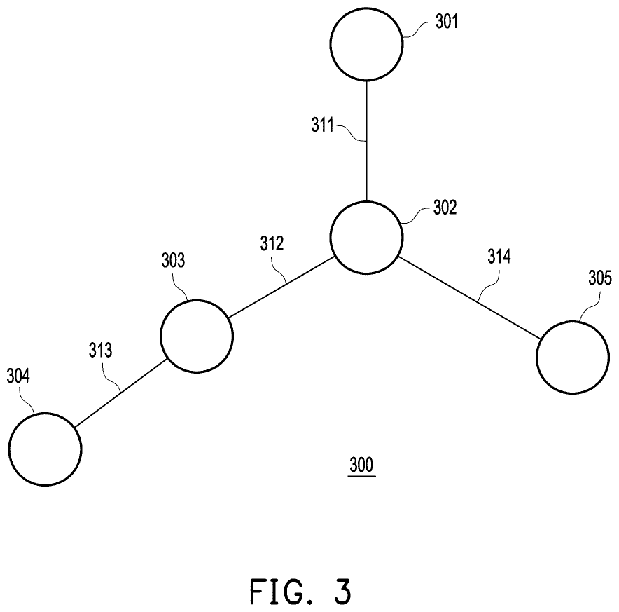

In some embodiments, a bottom-up hierarchical clustering algorithm may be adopted. For example, the similarity between each pair of feature vectors may be calculated first. This similarity may be Cosine similarity, Euclidean Distance, etc., but the present invention is not limited to these. If the similarity between two feature vectors is greater than a similarity threshold, these two feature vectors are clustered into the same group. Other feature vectors may also join this group through similarity calculations. Each group may be used to construct a graph. FIG. 3 is a schematic diagram illustrating the construction of a graph based on a group according to the first embodiment. In the example of FIG. 3, the graph includes vertices 301 to 305 and edges 311 to 314. These vertices 301 to 305 correspond to feature vectors within the same group respectively, and each edge indicates that the similarity between the corresponding two feature vectors is greater than the similarity threshold. For example, the edge 311 connects to the vertices 301 and 302, thus the edge 311 indicates that the similarity between the two feature vectors corresponding to the vertices 301 and 302 is greater than the similarity threshold.

Please refer back to FIG. 2. In step 204, a representative feature vector is extracted from each group, and these representative feature vectors correspond to representative training samples. In the example of FIG. 3, the vertex with the largest number of connections among all vertices 301 to 305 is set as the representative feature vector. The number of connections is also called the degree of the vertex. In this example, the vertex 301 has a connection number of 1, the vertex 302 has a connection number of 3, the vertex 303 has a connection number of 2, and the vertices 304 and 305 both have a connection number of 1. Therefore, the vertex 302 has the largest number of connections, and the feature vector corresponding to the vertex 302 will be set as the representative feature vector. In other embodiments, the average vector of all feature vectors within the group is calculated, and the feature vector closest to this average vector is taken as the representative feature vector. Alternatively, in other embodiments, principal component analysis (PCA) is performed on all feature vectors within the group, and then the principal component with the largest eigenvalue is found. The feature vector closest to this principal component is set as the representative feature vector. Since clustering has been performed first, the quantity of all representative training samples will be less than the quantity of original training samples.

In step 205, the second machine learning model is trained according to the representative training samples. Here, the representative training samples may be directly used as input to the second machine learning model for training, or other processing may be performed on the representative training samples before training. Since the quantity of representative training samples is less than the quantity of original training samples, this training process will take less time. Because the representative training samples include information from similar training samples, there will not be much reduction in performance.

In some embodiments, the second machine learning model is a pre-trained model, for example, BERT. In this embodiment, the second machine learning model is fine-tuned according to multiple representative training samples. This fine-tuning process may include Low-Rank Adaptation (LoRA), adapter, Distillation Fine-Tuning, etc. The fine-tuned model may be applied in specific technical fields including steel refining, semiconductors, finance, etc., which is not limited in the invention. In some embodiments, the aforementioned pre-trained model is a language model. The pre-trained model already includes information from many texts, including some common sense and grammar, but contains less information about specific technical fields. Therefore, using representative training samples to train the second machine learning model can add information from specific technical fields. Although the quantity of samples is reduced, it also removes noise or redundant information, so there will not be much reduction in performance. Alternatively, in some embodiments, the second machine learning model is used to generate videos or images. The pre-trained model lacks information about a certain artistic style, and the second machine learning model is fine-tuned to produce videos or images with new artistic styles.

For example, in some embodiments, a question-answering model about steelmaking is developed, so each training sample includes a question and an answer. The questions in different training samples may be very similar, such as “What is stainless steel?”, “What material is stainless steel made of?”, “What is the composition of stainless steel?”. These questions are essentially very similar to each other, and there exists some redundant information among these training samples. Through the aforementioned method, these training samples will be grouped into the same group. Moreover, if there are too many similar training samples, there may be a problem of quantity imbalance. For instance, if the quantity of samples in one category is far greater than the quantity of samples in another category, the training of the entire model will be biased towards the category with more samples. However, in the above embodiment, by using representative training samples for training, the problems of redundant information and quantity imbalance can be solved.

### Second Embodiment

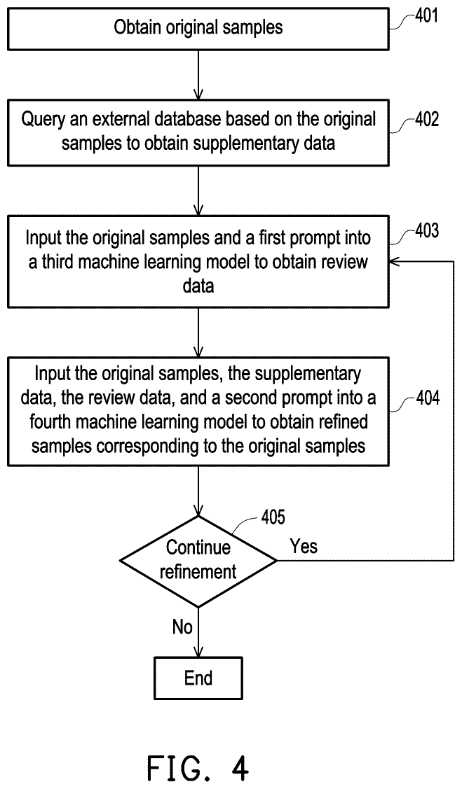

The second embodiment proposes a refinement method for training samples, which may improve the quality of the training samples. FIG. 4 is a flowchart illustrating the refinement method for training samples according to the second embodiment. Referring to FIG. 4, at step 401, original samples are obtained. These original samples may be images, text, audio signals, data measured by various sensors, etc., which is not limited in the invention.

At step 402, an external database is queried based on the original samples to obtain supplementary data. The aforementioned external database may be, for example, a database related to a specific technical field, which may include text or audio-visual data. Any retrieval algorithm may be used to query the database; this invention is not limited in this regard. For example, the original samples may include text, while the external database contains multiple articles. In some embodiments, the TF-IDF (Term Frequency-Inverse Document Frequency) index may be used to find relevant paragraphs, articles, or sentences as supplementary data. Alternatively, the original samples may be converted into feature vectors, and the articles in the external database may also be converted into feature vectors. By calculating the similarity of feature vectors, relevant supplementary data can be found. In some embodiments, the original samples are images, and the external database also contains images or videos. Similarly, feature vector calculations can be used to find similar images or videos from the external database. In some embodiments, the original samples are used to train a question-answering model, so the original samples include text such as questions and answers. At step 402, the external database may be queried based on the questions in the original samples to obtain supplementary data.

At step 403, the original samples and a first prompt are input into a third machine learning model to obtain review data. The third machine learning model is used to evaluate the quality of the original samples. The review data may include text or scores representing quality.

In some embodiments, the original samples are used to train a question-answering model, so the original samples include text such as questions and answers. The third machine learning model is a language model, and the first prompt is configured to instruct evaluating of the correctness, fluency, and completeness of the answer. For example, the question in the original sample may be “According to the different degrees of deoxidation, why are there distinctions between rimmed steel ingots, killed steel ingots, and semi-killed steel ingots?”, and the answer may be “Based on the different degrees of deoxidation before casting, steel ingots can be classified into rimmed steel ingots, killed steel ingots, and semi-killed steel ingots”. After providing the question and answer from the original sample to the third machine learning model, the first prompt may be set as “For the given question, please evaluate whether the answer is correct, fluent, and complete”. The review data provided by the third machine learning model may be, for example, “This answer is correct, but not complete enough”.

In some embodiments, the original samples are generated images, with the goal of generating Impressionist-style images. The third machine learning model may be a large language model capable of receiving images. After providing the original samples to the third machine learning model, the aforementioned first prompt may be “Please evaluate whether this image conforms to the Impressionist style”. In some embodiments, the original samples are used to train a customer service model, and the aforementioned first prompt may include “Please evaluate whether this response is concise and polite”.

At step 404, the original samples, the supplementary data obtained in step 402, the review data obtained in step 403, and a second prompt are input into a fourth machine learning model to obtain refined samples corresponding to the original samples. The fourth machine learning model is different from the third machine learning model. In this embodiment, the third machine learning model is used for reviewing, while the fourth machine learning model is used for refining samples. This is because different machine learning models excel at different tasks, and separating the reviewing and refining into two steps may also avoid the blind spots of a single model.

Continuing with the example of the question-answering model, the fourth machine learning model is also a language model, and the second prompt is configured to instruct adjusting the answer based on the supplementary data and the review data. For example, the second prompt may be “Based on the above question, supplementary data, and review data, directly refine the answer to make it more accurate and complete”. Then, the output of the fourth machine learning model may be used as the refined sample. Taking the aforementioned example about steel ingots, the output of the fourth machine learning model may be “The varying degrees of deoxidation allow us to differentiate between rimmed steel ingots, killed steel ingots, and semi-killed steel ingots, each with its own characteristics and specific applications. It is also crucial to consider the best choice of ingot before casting, which involves different decarburization processes and mechanical property requirements. Rimmed steel ingots, also known as ‘open-hearth’ ingots, have surfaces that are not specially treated, making it advantageous to place a molten steel distributor at the top to facilitate casting using the hollow press method. Its advantages include . . . ”, which is more complete compared to the previous answer.

In the above example of generating images, the second prompt may be “Based on the above image, supplementary data, and review data, directly redraw the image to make it closer to the Impressionist style”, and the fourth machine learning model may generate a new image as the refined sample.

Next, at step 405, it is determined whether to continue refinement. In some embodiments, the determination of whether to continue refinement may be based on the review data output by the third machine learning model. For example, when the review data is text, it may be determined whether any of the accuracy, fluency, and completeness is insufficient; if so, the refinement continues. Alternatively, when the review data is a score, it may be determined whether this score is greater than a threshold; if so, the refinement stops. In some embodiments, it may also be determined whether the number of refinement iterations has reached a threshold; if so, the refinement stops.

If the result of the step 405 is yes, then the original sample is replaced with the refined sample and the steps 403 and 404 are repeated. Continuing with the example of the question-answering model, the refined sample may be used to replace the answer in the original sample. In the step 403, the original question and the updated answer are input to the third machine learning model. In the step 404, the question from the original sample, the updated answer, new review data, supplementary data, and the second prompt are input to the fourth machine learning model to refine the sample again.

If the result of step 405 is no, then the process of FIG. 4 ends. After multiple iteration of refinement, samples of better quality are produced. Subsequently, these samples may be used to perform the training of the machine learning model.

### Third Embodiment

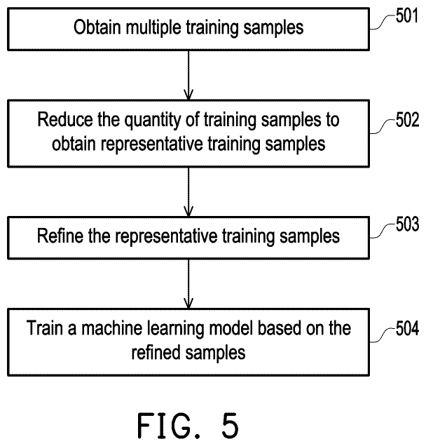

The third embodiment combines the aforementioned first embodiment and second embodiment, not only reducing the quantity of training samples but also improving the quality of the samples. FIG. 5 is a flowchart illustrating the training method according to the third embodiment. Referring to FIG. 5, at step 501, multiple training samples are obtained. At step 502, the quantity of training samples is reduced to obtain representative training samples. Step 502 may include steps 202 to 204 of FIG. 2. In other words, these training samples are clustered into multiple groups, and a representative training sample is extracted from each group.

Next, step 503 is performed to refine the representative training samples. Step 503 may include steps 402 to 405 of FIG. 4, where the original sample is replaced with the representative training sample. Notably, when performing the step 402, the external database may be queried based on all training samples in the group to which the representative training sample belongs.

Taking the question-answering model as an example again, each training sample includes a question and an answer. For instance, in a first group, the external database may be queried based on the questions from all training samples in this group. For each training sample's question, a piece of supplementary data is obtained, thus acquiring multiple pieces of supplementary data in total. When performing the step 403, the representative training sample of the first group and the first prompt are input to the third machine learning model to obtain review data. In performing the step 404, the representative training sample of the first group, multiple pieces of supplementary data, review data, and the second prompt are input to the fourth machine learning model to obtain a refined sample corresponding to the representative training sample. In other words, the second prompt is configured to instruct adjusting of the answer in the representative training sample of the first group according to the supplementary data and review data, making this answer more accurate, fluent, and complete. Since each representative training sample is refined with multiple pieces of supplementary data, the quality improvement is greater than when using a single piece of supplementary data.

After performing the step 503 for all representative training samples, multiple refined samples are obtained. Next, the step 504 of FIG. 5 is performed to train the second machine learning model based on the refined samples, for example, by fine-tuning a pretrained model according to the refined samples.

### Experimental Results

Please refer to the process of the third embodiment. In an experiment, the quantity of original training samples was 42144, and after clustering, the quantity of representative training samples became 17267. The aforementioned third machine learning model, for example, was Breeze-7b, while the fourth machine learning model could be Qwen2-7b. Please refer to the following Table 1 for the results, where GPT-4 scored the correctness, readability, and reasonableness.

TABLE 1

| | | | Reason- | Average |
|---|---|---|---|---|
| Experiment Number | Correctness | Readability | ableness | Score |
| 1(Training Sample) | 7.65 | 8.19 | 8.22 | 8.02 |
| 2(Representative | 8.51 | 8.82 | 8.88 | 8.78 |
| Training Samples) | | | | |
| 3(Train Samples + | 5.42 | 6.47 | 5.74 | 5.9 |
| Supplement Data) | | | | |
| Representative | 9.19 | 8.89 | 9.39 | 9.16 |
| Training Sample + | | | | |
| refine | | | | |

In experiment 1 of Table 1, only the original training samples were used to train the question-answering model, thus the sample size was 42144, with an average score of 8.02. In experiment 2, the sample size was first reduced, with the quantity of representative training samples being 17267, and the model was trained using these representative training samples (without refinement), resulting in an average score of 8.78. It can be observed that experiment 2 used fewer samples than experiment 1 but obtained better results. In experiment 3, the original training samples were used, and the external database was queried based on these training samples. After adding the supplementary data to the training samples, training was conducted, resulting in an average score of 5.9. In experiment 4, refined representative training samples were used for training, obtaining the average score of 9.16 (the highest among all experiments).

Moreover, using a smaller quantity of representative training samples may shorten the training time, while refined representative training samples contain more tokens, which would increase the training time. The combined effect of these two factors is shown in the following Table 2.

TABLE 2

| | Sample Size | Required Time | Token Quantity |
|---|---|---|---|
| Original Training Sample | 42145 | 10.38 hours | 4876611 |
| Representative Training | 17267 | 8.47 hours | 5033824 |
| Sample | | | |

From Table 2, it can be observed that although using refined representative training samples results in a higher number of tokens, the overall training time is still reduced by 22.5%. Therefore, this approach not only enhances training performance but also reduces training time.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A training method for a machine learning model and executed by an electronic device, the training method comprising:
obtaining a plurality of training samples;
inputting each of the training samples to a first machine learning model to obtain a feature vector correspondingly;
clustering the feature vectors corresponding to the training samples to obtain a plurality of groups, wherein each of the groups includes a portion of the feature vectors;
extracting a representative feature vector from each of the groups, wherein the representative feature vector corresponds to a representative training sample among the training samples, and a quantity of the representative training samples corresponding to the groups is less than a quantity of the training samples; and
training a second machine learning model according to the representative training samples.

2. The training method of claim 1, wherein the second machine learning model is a pretrained model.

3. The training method of claim 1, wherein the step of clustering the feature vectors corresponding to the training samples to obtain the groups includes:
calculating similarities between the feature vectors; and
if the similarity between two of the feature vectors is greater than a similarity threshold, clustering the two of the feature vectors into same one of the groups.

4. The training method of claim 3, wherein the step of extracting the representative feature vector from each of the groups includes:
establishing a graph for a first group among the groups, wherein the graph comprises a plurality of vertices and at least one edge, the vertices correspond to the feature vectors in the first group, and the at least one edge indicates that the similarity between the feature vectors in the first group is greater than the similarity threshold; and
setting one of the vertices with a largest number of connections as the representative feature vector.

5. The training method of claim 1, wherein each of the training samples comprises a question and an answer, and the step of training the second machine learning model according to the representative training samples includes:
for a first group among the groups, querying an external database according to the questions of the training samples in the first group to obtain supplementary data;
inputting the representative training sample of the first group and a first prompt to a third machine learning model to obtain review data;
inputting the representative training sample of the first group, the supplementary data, the review data, and a second prompt to a fourth machine learning model to obtain a refined sample corresponding to the representative training sample, wherein the fourth machine learning model is different from the third machine learning model; and
training the second machine learning model according to the refined sample.

6. The refinement method of claim 5, wherein the third machine learning model is a language model, and the first prompt is configured to instruct evaluating correctness, fluency, and completeness of the answer.

7. The refinement method of claim 6, wherein the fourth machine learning model is a language model, and the second prompt is configured to instruct adjusting the answer of the representative training sample of the first group according to the supplementary data and the review data.

8. A refinement method executed by an electronic device, the refinement method comprising:
(a) obtaining an original sample;
(b) querying an external database according to the original sample to obtain supplementary data;
(c) inputting the original sample and a first prompt to a first machine learning model to obtain review data; and
(d) inputting the original sample, the supplementary data, the review data, and a second prompt to a second machine learning model to obtain a refined sample corresponding to the original sample, wherein the second machine learning model is different from the first machine learning model.

9. The refinement method of claim 8, further comprising:
replacing the original sample with the refined sample and repeatedly executing the step (c) and the step (d).

10. The refinement method of claim 8, wherein the original sample includes a question and an answer, and the step (b) comprises:
querying the external database according to the question to obtain the supplementary data.

11. The refinement method of claim 10, wherein the original sample comprises a text, the first machine learning model is a language model, and the first prompt is configured to instruct evaluating correctness, fluency, and completeness of the answer.

12. The refinement method of claim 10, wherein the second machine learning model is a language model, and the second prompt is configured to instruct adjusting the answer according to the supplementary data and the review data.

13. An electronic device, including:
a memory, storing a plurality of instructions;
a processor, communicatively connected to the memory, and configured to execute the instructions to perform a plurality of steps:
obtaining a plurality of training samples;
inputting each of the training samples to a first machine learning model to obtain a feature vector correspondingly;
clustering the feature vectors corresponding to the training samples to obtain a plurality of groups, wherein each of the groups comprises a portion of the feature vectors;
extracting a representative feature vector from each of the groups, wherein the representative feature vector corresponding to a representative training sample in the training samples, and a quantity of the representative training samples corresponding to the groups is less than a quantity of the training samples; and
training a second machine learning model according to the representative training samples.

14. The electronic device of claim 13, wherein the second machine learning model is a pretrained model.

15. The electronic device of claim 13, wherein the step of clustering the feature vectors corresponding to the training samples to obtain the groups includes:
calculating similarities between the feature vectors; and
if the similarity between two of the feature vectors is greater than a similarity threshold, clustering the two of the feature vectors into same one of the groups.

16. The electronic device of claim 15, wherein the step of extracting the representative feature vector from each of the groups includes:
establishing a graph for a first group among the groups, wherein the graph comprises a plurality of vertices and at least one edge, the vertices correspond to the feature vectors in the first group, the at least one edge indicates that the similarity between the feature vectors in the first group is greater than the similarity threshold; and
setting one of the vertices with a largest number of connections as the representative feature vector.

17. The electronic device of claim 13, wherein each of the training samples comprises a question and an answer, the step of training the second machine learning model according to the representative training samples comprises:
for a first group among the groups, querying an external database according to the questions of the training samples in the first group to obtain supplementary data;
inputting the representative training sample of the first group and a first prompt to a third machine learning model to obtain review data;
inputting the representative training sample of the first group, the supplementary data, the review data, and a second prompt to a fourth machine learning model to obtain a refined sample corresponding to the representative training sample, wherein the fourth machine learning model is different from the third machine learning model; and
training the second machine learning model according to the refined sample.

18. The electronic device of claim 17, wherein the third machine learning model is a language model, and the first prompt is configured to instruct evaluating correctness, fluency, and completeness of the answer.

19. The electronic device of claim 18, wherein the fourth machine learning model is a language model, and the second prompt is configured to instruct adjusting the answer of the representative training sample of the first group according to the supplementary data and the review data.
